(19) United States
(12) Patent Application Publication
(10) Pub. No.: US 2003/0145531 A1
(43) Pub. Date: Aug. 7, 2003

(54) Apparatus & method for shimming surfaces

(76) Inventor: Bruce Holder, Roachdale, IN (US)

Correspondence Address: BARNES & THORNBURG, 11 SOUTH MERIDIAN, INDIANAPOLIS, IN, 46204

(21) Appl. No.: 10/293,630

(22) Filed: Nov. 13, 2002

Related U.S. Application Data
(63) Continuation-in-part of application No. 10/068,189, filed on Feb. 5, 2002, now abandoned.

(51) Int. Cl. G09F 3/00; B65D 65/28; E04G 1/22; F16M 11/24

(52) U.S. Cl. 52/98; 52/126.1; 428/43; 248/188.2

(57) ABSTRACT

A shim is disclosed. The shim includes a body member having (i) a top wall segment having a first end and a second end, (ii) a first end wall segment attached to and extending from the first end of the top wall segment, (iii) a second end wall segment attached to and extending from the second end of the top wall segment, and (iv) a bottom wall segment having a third end and a fourth end, the third end of the bottom wall segment being attached to the first end wall segment, and the fourth end of the bottom wall segment being attached to the second end wall segment. The top wall segment, the first end wall segment, the second end wall segment and the bottom wall segment are all made from a plastic material. Additionally, the shim may include a plurality of latitudinal apertures.

This application is a Continuation-in-Part of U.S. patent application Ser. No. 10/068,189 which was filed on Feb. 05, 2002 and which is hereby incorporated by reference herein.

### TECHNICAL FIELD OF THE DISCLOSURE

The present invention generally relates to a shim and an associated method of adjusting the spatial relationship between a first surface and a second surface. The present invention particularly relates to a shim having a body member made from a plastic material and an associated method of adjusting the spatial relationship between a first surface and a second surface with the shim.

### BACKGROUND OF THE DISCLOSURE

Typically, a shim is a thin piece of wood which is used to adjust the spatial relationship between two surfaces. For example, a shim can be placed in between a surface defined on a frame member of a door and a surface defined on a frame member of a house. Once the shim is positioned in the above described manner, a tool, such as a hammer, can be utilized to advance the shim between the two surfaces, and thus adjust the spatial relationship between the door and the frame member of the house. However, heretofore, a problem with shims is that they tend to break or splinter when they are driven between the two surfaces. The breaking of shims during the process of trying to adjust the spatial relationship between, for example a door and a frame member of a house, is inconvenient and a source of frustration for the person using the shim. In addition, the undesirable breakage of shims can be dangerous and costly.

Therefore, in light of the above discussion, it is apparent that a shim and an associated method of adjusting the spatial relationship between a first surface and a second surface, which addresses one or more of the above discussed drawbacks is desirable.

### SUMMARY OF THE DISCLOSURE

In accordance with one embodiment of the present invention, there is provided a shim. The shim includes a body member having (i) a top wall segment having a first end and a second end, (ii) a first end wall segment attached to and extending from the first end of said top wall segment, (iii) a second end wall segment attached to and extending from the second end of said top wall segment, and (iv) a bottom wall segment having a third end and a fourth end, the third end of the bottom wall segment being attached to said first end wall segment, and the fourth end of the bottom wall segment being attached to said second end wall segment. At least one of the top wall segment and bottom wall segment includes a plurality of latitudinal apertures.

Pursuant to another embodiment of the present invention, there is provided a method of adjusting the spatial relationship between a first surface and a second surface. The method includes (a) inserting a shim having a body member made of plastic and including plurality of latitudinal apertures into a space defined between the first surface and the second surface such that the body member is in contact with the first surface and said second surface and (b) advancing the body member into the space so that the first surface is moved relative to the second surface.

According to yet another embodiment of the present invention, there is provided a method of adjusting the spatial relationship between a first surface and a second surface. The method includes (a) inserting a first shim having a body member made of plastic and including a plurality of latitudinal apertures into a space defined between the first surface and the second surface such that the body member is in contact with the first surface, (b) inserting a second shim having a body member made of plastic and including a plurality of latitudinal apertures into the space such that the body member is in contact with the second surface, and (c) advancing the body member of the first shim and the body member of the second shim into the space so that at least one of the first surface and the second surface is moved.

According to a further embodiment of the present invention, there is provided a shim. The shim includes a body member made out of a plastic material. The body member has a plurality of latitudinal apertures.

The above and other objects, features, and advantages of the present invention will become apparent from the following description and attached drawings.

### BRIEF DESCRIPTION OF THE DRAWINGS

The detailed description particularly refers to the accompanying figures in which:

FIG. 1 is a top elevational view of a shim which incorporates the features of the present invention therein;

FIG. 2 is a side elevational view of the shim shown in FIG. 1 taken along the line 2-2 of FIG. 1;

FIG. 3 is a fragmentary side elevational view of the shim shown in FIG. 1 being inserted into a space defined between a surface of a frame member and a surface of another frame member (note that a fragmentary view of a hammer is also shown);

FIG. 4a is a top elevational view of a shim which incorporates the features of the present invention therein and includes a plurality of latitudinal apertures;

FIG. 4b is a bottom elevational view of the shim shown in FIG. 4a;

FIG. 4c is a side evelvational view of the shim shown in FIG. 4a taken along the line 4c-4c of FIG. 4a;

FIG. 5a-d are fragmentary side elevational views of a shim which incorporates the features of the present invention therein and includes a pluarlity of latitudinal apertures;

FIG. 6 is a fragmentary side elevational view of the shim shown in FIG. 4a-c being inserted into a space defined between a surface of a frame member and a surface of another frame member; and

FIG. 7 is a fragmentary side elevational view of the shim shown in FIG. 4a-c being inserted in a first direction into a space defined between a surface of a frame member and a surface of another frame member and another similar shim being inserted in a second direction into the same space.

### DETAILED DESCRIPTION OF THE DISCLOSURE

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

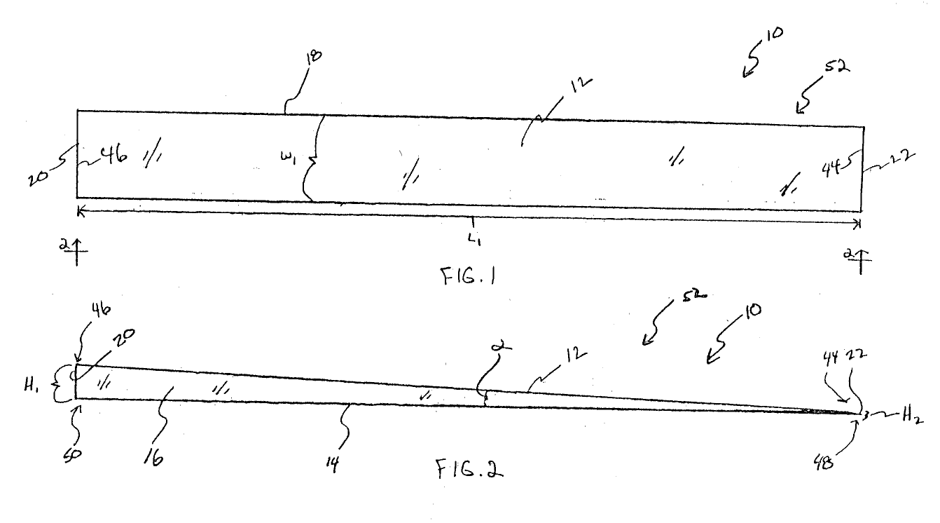

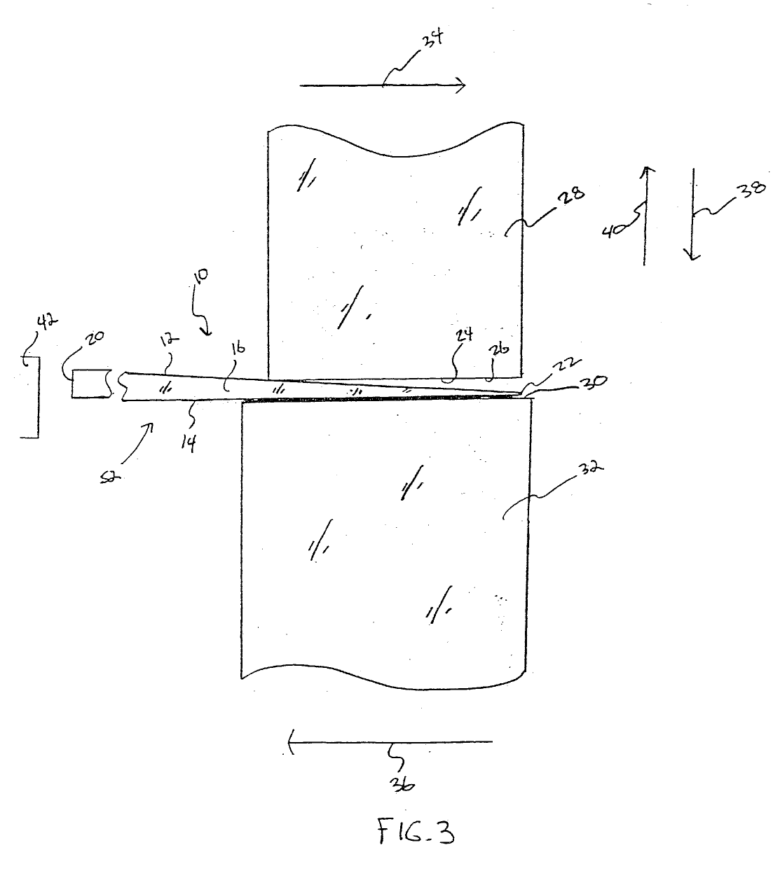

Referring now to FIGS. 1 and 2, there is shown a shim 10 which incorporates the features of the present invention therein. Shim 10 includes a body member 52. Body member 52 includes a top wall segment 12 having an end 44 and an end 46. Body member 52 also includes an end wall segment 22 attached to and extending from end 44 of top wall segment 12. Body member 52 further includes an end wall segment 20 attached to and extending from end 46 of top wall segment 12. Body member 52 still further includes a bottom wall segment 14 having an end 48 and an end 50. Body member 52 also includes a side wall segment 16 interposed between and attached to top wall segment 12 and bottom wall segment 14. Body wall segment 18 (which is substantially identical to side wall segment 16) interposed between and attached to top wall segment 12 and bottom wall member 52 also includes a side segment 14. End 50 of bottom wall segment 14 is attached to end wall segment 20. End 48 of bottom wall segment 14 is attached to end wall segment 22. It should be appreciated that top wall segment 12 and bottom wall segment 14 are substantially identical and, as previously mentioned, a side wall segment 18 and side wall segment 16 are also substantially identical.

Preferably, body member 52 is constructed from a solid piece of plastic material. What is meant herein by plastic material is a polymeric material of large molecular weight which can be shaped by flow. Examples of plastic material which can be utilized in the present invention include, but are not limited to, Poly(decamethylene carboxamide) poly(11-aiminoundecanoic acid) (nylon 11, Rislan), Poly(hexamethylene adipamide) (nylon 66, Bri-Nylon),Poly(hexamethylene sebacamide) (nylon 610), Polycaprolactam poly(pentamethylene carboxamide) poly(6-aminphexanoic, acid) (nylon 6, Perlon, Caprolan), Poly(ethylene terephthalate) (Dacro, Terylene, Fortrel, Mylar), Poly(butylene terephthalate), Poly(4,4′-isopropylidine-diphenyl carbonate) poly(4,4′-carbonato-2,2-diphenylpropane) (Lexan), Polyformaldehyde (Delrin, Celcon), Poly(2,6-xylenol) poly(2,6-dimethyl-1,4-phenylene oxide) (Parlene), Poly(pheno-formaldehyde) resins (Bakelite), Pdly(melamine-formaldehyde) resins, (Udel polysulfone), Poly(acrylonitril-ebutadiene-styrene) copolymers (ABS polymers), and Polyethylene polymethylene, Poly(vinyl chloride) (PVC). It should be appreciated that having body member 52 made from a plastic material is an advantage of the present invention. In particular, having body member 52 made from a plastic material imparts greater strength to shim 10 and thus substantially prevents body member 52 from undesirably breaking during use. For example, shim 10 can be struck with a hammer 42 (see FIG. 3) without undesirably breaking or shattering. However, shim 10 can be purposefully cut or broken, if and when, desired. Furthermore, any appropriate plastic material can be utilized to make shim 10 as long as it (i) is strong enough to substantially prevent the undesirable breaking or shattering of body member 52, while still allowing the purposeful breaking or cutting thereof and (ii) is strong enough so that it does not substantially bend or deform when a force is applied thereto (e.g. being struck with a hammer) so as to drive shim 10 in between two closely spaced surfaces. In other words, the plastic material shim 10 is made from must be stiff and strong enough such that body member 52 can have a sufficient force applied thereto so as to drive body member 52 in between two closely spaced surfaces without body member 52 bending or deforming to a degree which prevents body member 52 from being efficiently driven between the two aforementioned surfaces.

Still referring to FIGS. 1 and 2, shim 10 is preferably shaped in the form of a wedge. In particular, as shown in FIG. 2, end wall segment 20 has a height H₁ and end wall segment 22 has a height H₂, H₁ is greater than H₂ so that an angle α is defined between top wall segment 12 and bottom wall segment 14. Preferably, angle α is less than 10°. More preferably, angle α is about 2°. In one embodiment of the present invention, H₁ of end wall segment 20 can be about ⅜ of an inch and H₂ of end wall segment 22 can be about 1/32 of an inch. It should also be understood that top wall segment 12 has a length L₁ and a width W₁ and in one embodiment of the present invention L₁ can be about 14 inches and W₁ can be about 1.5 inches. Additionally, as shown in FIG. 2, top wall segment 12 and end wall segment 20 define an angle ω. Illustratively, angle ω is 90°, however, angle ω may be less than 90°. When angle ω is 90°, end wall segment 20 provides a vertical surface in relation to bottom wall segment 14 and may improve the ease of inserting shim 10 with use of force-producing tool, for example a hammer. Having shim 10 configured in the above described manner advantageously facilitates the insertion of shim 10 in between two closely spaced surfaces.

As shown in FIG. 3, shim 10 is utilized to adjust the spatial relationship between surface 26 defined on frame member 28 and surface 30 defined on frame member 32. In particular, body member 52 of shim 10 is inserted into a space 24 defined between surface 26 and surface 30 in the direction indicated by arrow 34 so that body member 52 is in contact with surface 26 and surface 30. Inserting shim 10 into space 24 in the direction indicated by arrow 34 results in frame member 28, and thus surface 26, moving relative to frame member 32 in the direction indicated by arrow 40. On the other hand, withdrawing shim 10 out of space 24 in the direction indicated by arrow 36 results in frame member 28, and thus surface 26, moving relative to frame member 32 in the direction indicated by arrow 38. Thus, it should be understood that shim 10 can be moved in the above described manner until frame member 28 is appropriately positioned relative to frame member 32. Once frame member 28 is appropriately positioned relative to frame member 32, frame member 28 can be nailed or otherwise fixed in relation to frame member 32 so as to maintain its desired position. Furthermore, if desired, once frame member 28 is appropriately positioned relative to frame member 32 with shim 10, shim 10 can be purposefully cut, or broken off, at a desired location, e.g. at a location so that no portion of shim 10 extends out of space 24, so that the portion remaining in space 24 facilitates maintaining the desired position of frame member 28. Note that the present invention is not limited to just one surface moving relative to another, both surfaces moving relative to another is also contemplated. Also note that, if necessary, shim 10 can be moved in the directions indicated by arrows 34 and 36 with the assistance of a tool since body member 52 is made from a plastic material and thus is strong enough to take such punishment. For example, shim 10 can be struck with hammer 42 without breaking or shattering.

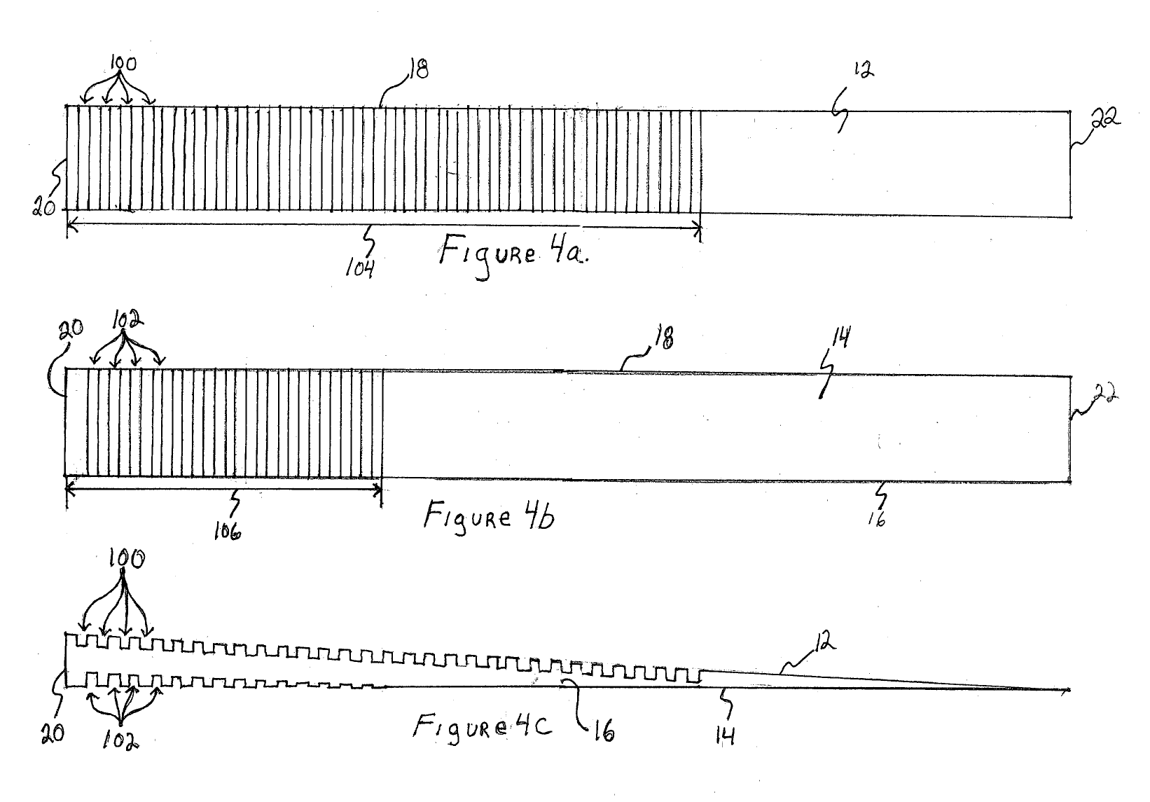

In another embodiment, as shown in FIG. 4a-c, the body member 52 of the shim 10 may include a plurality of latitudinal apertures 100, 102 disposed upon the top wall segment 12 and the bottom wall segment 14 to facilitate the trimming or cutting of the shim 10. In particular, the apertures 100, 102 provide a latitudinal guide for a blade of a cutting utensil to travel along. Additionally, the apertures 100, 102 cooperate to decrease the thickness of body member 52 in the area to be trimmed thereby improving the ease of snapping or breaking shim 10 during the trimming process. Illustratively, the apertures 100, 102 extend in a latitudinal direction across the segments 12, 14, respectively, from body wall segment 16 to body wall segment 18. As shown in FIG. 4a, the plurality of apertures 100 are disposed upon top wall segment 12 for a length 104. Similarly, as shown in FIG. 4b, the plurality of troughs 104 are disposed upon bottom wall segment 14 for a length 106. Illustratively, length 104 is greater than length 106, however, it is anticipated that the lengths 104, 106 may range between zero (e.g. one side having no apertures) to the full length of the shim L₁. In practice, the lengths 104, 106 may be constrained by such factors as the thickness of the shim as the length approaches the end wall segment 22.

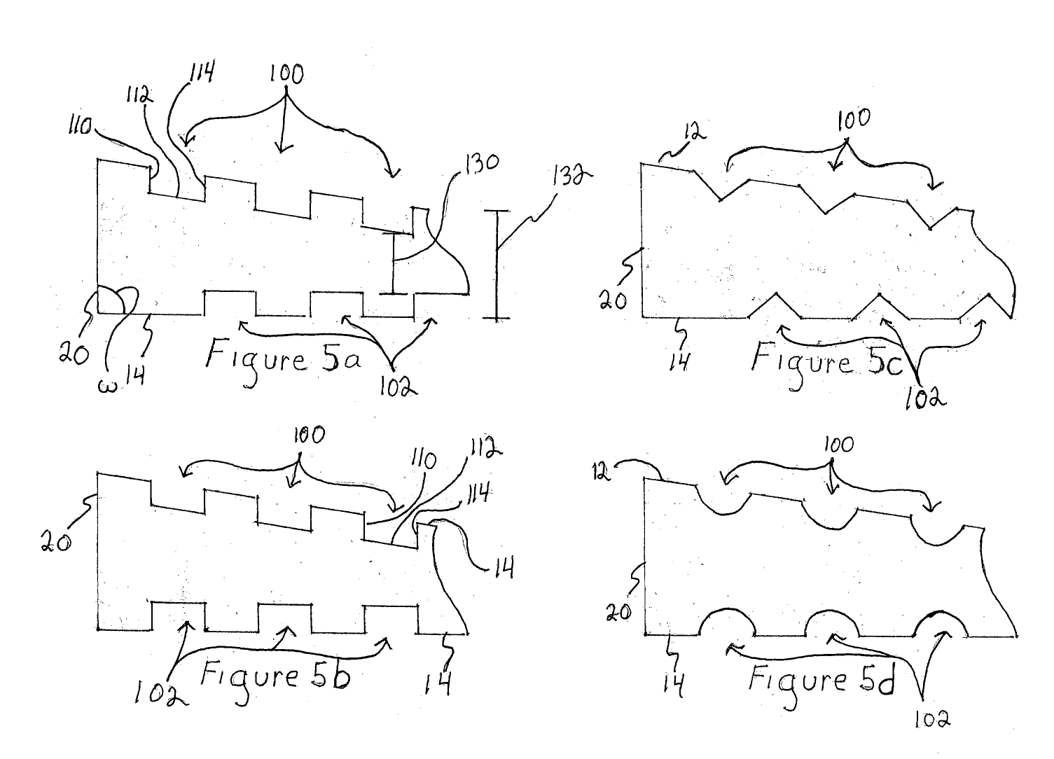

Apertures 100, 102 may be horizontally offset from each other as shown in FIGS. 5a, 5c, and 5d. Alternatively, the apertures 100, 102 may be horizontally aligned with each other as shown in FIG. 5b. Horizontally offsetting apertures 100, 102 may allow an increase in one of length 104 and length 106. It should be appreciated that any amount of horizontal offset of apertures 100, 102 may allow an increase in one of length 104 and length 106.

Illustratively, apertures 100, 102 include a first sidewall 102, a bottom wall 104, and a second sidewall 106, as shown in FIG. 5a. The sidewall 102 is coupled to the top wall segment 12 and to the bottom wall 104. Similarly, sidewall 104 is coupled to the top wall segment 12 and to the bottom wall 104. Bottom wall 104, therefore, is coupled to sidewall 102 and sidewall 104. Sidewalls 102, bottom walls 104, and sidewalls 106 cooperate to define each individual aperture 100, 102. As shown in FIGS. 5a-5d, the illustrative cross-section of apertures 102, 104 is trapazodial. However, it is anticipated that other cross-section profiles may be used. For example, apertures having a triangular cross-section as illustratively shown in FIG. 5c, a semi-circular cross-section as illustratively shown in FIG. 5d, or any cross-section profile that provides a guide for a cutting tool and improves the ease of breaking or snapping shim 10 may be used. In particular, any cross-section profile that reduces the thickness of shim 10 in areas of shim 10 which are desirable areas within which to cut, trim, or break shim 10 may be used. For example, as shown in FIG. 5a, a particular area of shim 10 including apertures 100, 102 may have a reduced height 130 defined between the bottom wall 104 of aperture 100 and the bottom wall 104 of aperture 102. In comparison, a shim which does not include apertures 100, 102 may have a height of 132 which is greater than the height 130. As shown illustratively in FIG. 5a, apertures 100, 102 reduce the height of shim 10 in the areas of apertures 100, 102 and thereby improve the ease of breaking or snapping shim 10 in these areas.

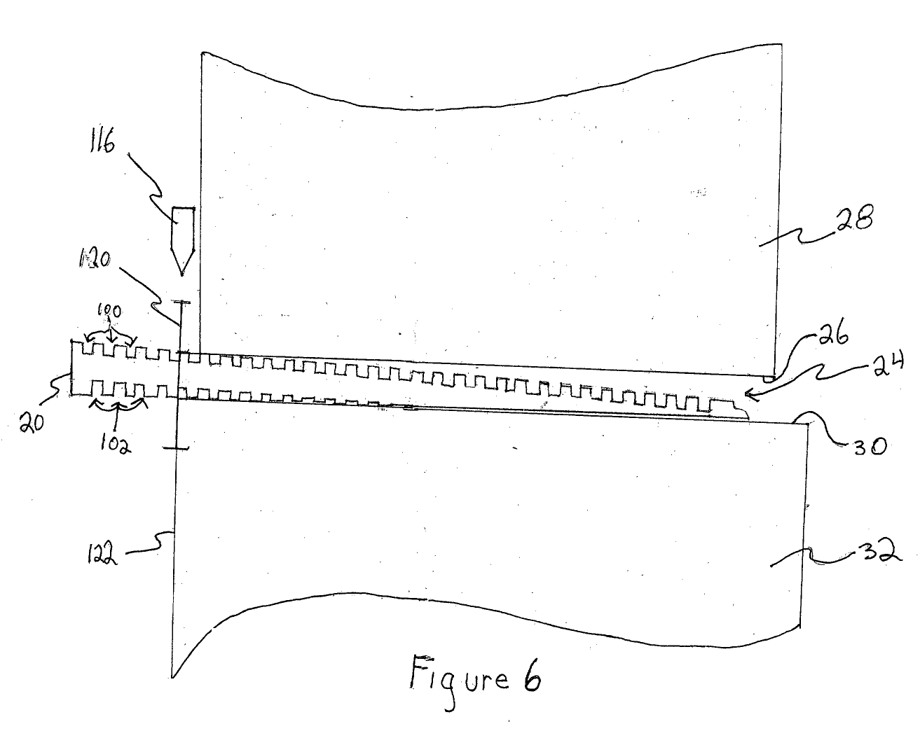

As shown illustratively in FIG. 6, a shim 10 including latitudinal apertures 100, 102 may be utilized in a similar manner as described above in relation to FIG. 3. In particular, shim 10 is inserted into the space 24 defined between surface 26 and surface 30 in the direction indicated by arrow 34 so that body member 52 is in contact with surface 26 and surface 30 thereby moving frame member 28 relative to frame member 32 in the direction indicated by arrow 40. Once frame member 28 is appropriately positioned relative to frame member 32 and optionally fixed in place, shim 10 can be purposefully cut, or broken off, at a desired location, e. g. at a location so that no portion of shim 10 extends out of space 24. For example, shim 10 may be trimmed along a line 120 which is vertically aligned with an outside surface 122 of frame member 32. In particular, a cutting utensil 116 may be employed to cut or trim shim 10 along one of the apertures as depicted in FIG. 6. Alternatively, shim 10 can be broken or “snapped” along one of the apertures with use of an applied force. Apertures 100, 102 improve the ease of breaking, snapping, or trimming shim 10 in a desired location indicated by a selected aperture by providing a guide for a cutting utensil and decreasing the thickness of the shim 10 in the area of shim 10 to be trimmed.

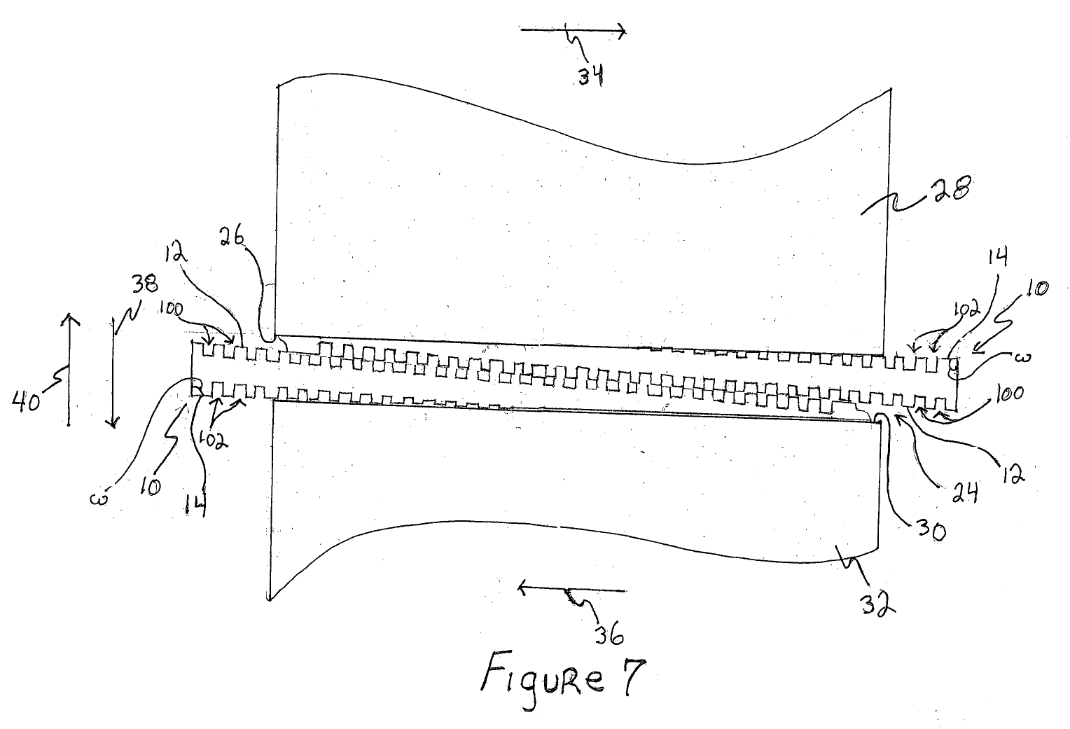

Alternatively, two shims 10, each including apertures 100, 102, may be used cooperatively to move frame member 28 relative to frame member 32 as shown illustratively in FIG. 7. In particular, body member 52 of a first shim 10 including apertures 100, 102 is inserted into the space 24 defined between surface 26 and surface 30 in the direction indicated by arrow 34 so that bottom wall segment 14 is in contact with one of surface 30. A second shim 10 including apertures 100, 102 is inserted into the same space 24 in the direction indicated by arrow 36 so that bottom wall segment 14 is in contact with the in and surface 26. Additionally, in this configuration, the top wall surface 12 of each shim 10 is abutted or confronted to each other. Typically the first and second shims 10 are inserted contemporaneously and thereby cooperate to move frame member 28, and thus surface 26, relative to frame member 32 in the direction indicated by arrow 40. On the other hand, withdrawing the first shim 10 in a direction indicated by arrow 36 and withdrawing the second shim in a direction indicated by arrow 34 results in frame member 28 moving relative to frame member 32 in the direction indicated by arrow 38. The first and second shims 10 can be inserted and maneuvered in unison or independently while positioning the shims 10 within the space 24. Once frame member 28 is appropriately positioned relative to frame member 32, frame member 28 can be nailed or otherwise fixed in relation to frame member 32 so as to maintain its desired position. Furthermore, if desired, once frame member 28 is appropriately positioned relative to frame member 32 with the first and second shims 10, the shims 10 may be purposefully cut, or broken off, at a desired location, e.g. at a location so that no portion of shims 10 extend out of space 24, so that the portion remaining in space 24 facilitates maintaining the desired position of frame member 28. In particular the first and second shims 10 may be cut, broken, or otherwise trimmed along one of the apertures 100 or apertures 102. Note that if angle ω is 90°, the first and second shims 10 cooperate to position the bottom wall segments 14 of the first and second shims 10 parallel to the surfaces 26, 30 and thereby increase the contact surface area of the first and second shims 10 and respective frame members 28, 32. Increasing the contact surface area of the first and second shims 10 and the respective frame members 28, 32 may improve the support of frame members 28, 32 during the insertions of the first and second shims and the resultant movement of the frame member 28.

Therefore, in light of the above discussion it should be appreciated that shim 10 can be utilized in the above described manner without undesirably breaking or shattering. For example, shim 10 can be utilized in the above described manner to adjust the position of surfaces defined on a door frame or a frame of a window without undesirably breaking or shattering. However, it should be appreciated that the use of shim 10 is not limited to adjusting window or door frames but rather can be used to adjust a wide variety of structural components. Thus the present invention addresses the aforementioned problem of shims tending to break or splinter when they are driven between two surfaces.

While the invention has been illustrated and described in detail in the drawings and foregoing description, such illustration and description is to be considered as exemplary and not restrictive in character, it being understood that only the preferred embodiments have been shown and described and that all changes and modifications that come within the spirit of the invention are desired to be protected.

1. A shim, comprising:
a body member which includes (i) a top wall segment having a first end and a second end, (ii) a first end wall segment attached to and extending from said first end of said top wall segment, (iii) a second end wall segment attached to and extending from said second end of said top wall segment, and (iv) a bottom wall segment having a third end and a fourth end, said third end of said bottom wall segment being attached to said first end wall segment, and said fourth end of said bottom wall segment being attached to said second end wall segment,
wherein at least one of said top wall segment and said bottom wall segment includes a plurality of latitudinal apertures.

2. The shim of claim 1, wherein:
said top wall segment, said first end wall segment, said second end wall segment, and said bottom wall segment are all made from a plastic material.

3. The shim of claim 1, wherein:
the cross-section of said latitudinal apertures is trapezoidal.

4. The shim of claim 1, wherein:
the cross-section of said latitudinal apertures is triangular.

5. The shim of claim 1, wherein:
the cross-section of the said latitudinal apertures is semicircular.

6. The shim of claim 1, wherein:
said body member further includes (i) a first side wall segment interposed between and attached to said top wall segment and said bottom wall segment, and (ii) a second side wall segment interposed between and attached to said top wall segment and said bottom wall segment,
wherein said first side wall segment and said second side walls segment are made from a plastic material.

7. The shim of claim 6, wherein:
said latitudinal apertures extend from said first side wall to said second side wall.

8. The shim of claim 6, wherein:
said latitudinal apertures are parallel to the said first end wall segment.

9. A method of adjusting the spatial relationship between a first surface and a second surface, comprising:
(a) inserting a shim having a body member made of plastic, the body member having a plurality latitudinal apertures, into a space defined between said first surface and said second surface such that said body member is in contact with said first surface and said second surface; and
(b) advancing said body member into said space so that said first surface is moved relative to said second surface.

10. The method of claim 9, wherein:
(b) includes striking said shim with a force producing tool.

11. The method of claim 9, further comprising:
(c) trimming said shim by removing a partial section of said shim.

12. The method of claim 11, wherein:
(c) trimming said shim includes cutting said shim along one of the latitudinal apertures.

13. The method of claim 11, wherein:
(c) trimming said shim includes breaking said shim along one of the latitudinal apertures.

14. The method of claim 9, wherein:
said first surface is disposed on a frame of a door.

15. The method of claim 9, wherein:
said first surface is disposed on a frame of a window.

16. A method of adjusting the spatial relationship between a first surface and a second surface, comprising:
(a) inserting a first shim having a body member made of plastic, the body member having a plurality of latitudinal apertures, into a space defined between said first surface and said second surface such that said body member is in contact with said first surface;
(b) inserting a second shim having a body member made of plastic, the body member having a plurality of latitudinal apertures, into said space such that said body member is in contact with the said second surface;
(c) advancing said body member of said first shim and said body member of said second shim into said space so that at least one of said first surface and said second surface is moved.

17. The method of claim 16, wherein:
(a) inserting a first shim and (b) inserting a second shim causes a first surface of said first shim to abut or confront a first surface of said second shim.

18. The method of claim 16, wherein:
(c) advancing said body member of said first shim and said body member of said second shim occurs contemporaneously.

19. The method of claim 16, further comprising:
(d) trimming said first shim by removing a partial section of said first shim, and
(e) trimming said second shim by removing a partial section of said second shim.

20. A shim, comprising:
a body member made out of a plastic material, said body member having a plurality of latitudinal apertures.
